(19) United States
(12) Patent Application Publication
(10) Pub. No.: US 2015/0314403 A1
(43) Pub. Date: Nov. 5, 2015

(54) ARRANGEMENT FOR LASER PROCESSING OF TURBINE COMPONENT

(71) Applicant: Siemens Energy, Inc., Orlando, FL (US)

(72) Inventors: Gerald J. Bruck, Oviedo, FL (US); Ahmed Kamel, Orlando, FL (US)

(73) Assignee: Siemens Energy, Inc., Orlando, FL (US)

(21) Appl. No.: 14/267,256

(22) Filed: May 1, 2014

(51) Int. Cl. B23K 37/04; B23P 6/00; B23K 26/34

(52) U.S. Cl. CPC B23K 37/0452; B23K 26/345; B23P 6/007

(57) ABSTRACT

An arrangement (10) for laser deposition repair of a gas turbine engine component (20). A processing surface (52) of the component is precisely positioned relative to a laser material deposition device (12), while service induced distortions of the component are accommodated by adjustment of a moveable base (28) remote from the processing surface, thereby allowing a plurality of like-design components to be processed without the necessity for part-specific dimensional verification or reprogramming of the device.

### FIELD OF THE INVENTION

This invention relates generally to the field of gas turbine engine component repair, and more particularly to an arrangement for securing a gas turbine engine component undergoing a laser heated material deposition process.

### BACKGROUND OF THE INVENTION

Gas turbine engine components, and particularly components of the engine exposed to the hot combustion gas, are subject to degradation during the operation of the engine. Degraded components are sometimes repaired rather than replaced due to the high manufacturing cost of these superalloy material components.

The present inventors have developed processes facilitating the repair of superalloy material components. United States Patent Application Publication U.S. 2013/0136868 A1, incorporated by reference herein, describes an additive manufacturing process wherein a powder including superalloy material and flux is selectively melted in layers to deposit the superalloy material. The use of flux as taught therein has made it possible to repair certain superalloy materials that had previously been considered to be not repairable due to their susceptibility to weld solidification cracking and strain age cracking. As a result of this discovery, the demand for the repair of such components is expected to increase significantly in the future.

The radially outermost tip of a rotating blade of the engine, commonly referred to as the squealer tip, is often subject to wear and erosion, resulting in a decrease in the efficiency of the engine due to the bypass of hot combustion gas around the blade. It is known to remove a degraded squealer tip, such as by grinding, and then to form a replacement squealer tip by welding, cold spray, laser cladding, or other material deposition process.

### BRIEF DESCRIPTION OF THE DRAWINGS

The invention is explained in the following description in view of the drawings that show:

FIG. 1 illustrates an arrangement for laser processing of a gas turbine engine blade.

FIG. 2 illustrates a split plate surrounding and positioning a gas turbine engine blade tip for a laser material deposition process.

FIG. 3 illustrates a production operation utilizing multiple fixtures on a rotating positioner for laser material deposition processing of gas turbine engine blades.

### DETAILED DESCRIPTION OF THE INVENTION

The use of laser cladding processes for the repair/replacement of gas turbine engine blade squealer tips is effective, but is often time consuming. Tight tolerance control is necessary for proper material deposition and accurate location of the new tip onto the existing blade top surface. Tolerance control is exacerbated by service-induced dimensional variations which regularly occur in a population of like-design blades. Such dimensional variations are traditionally accommodated by camera systems which measure the geometry of each individual part after it is secured into a processing fixture, and custom programming of the part manipulator and laser system responsive to the measured geometry.

The present inventors have realized that most of the service-induced dimensional variations in gas turbine blades occur along the airfoil portion of the blades between the root/platform area and the tip of the blade. The inventors have also discovered that the impact of these dimensional variations on a blade tip repair process can be alleviated by a fixturing arrangement which secures the blade along the laser processing plane, thereby allowing the service-driven distortions of the blade to locate below the processing plane without affecting the laser material deposition process. In contrast, prior art fixturing systems support the blade from its root, which is the attachment location for the blade within the gas turbine engine. While the blade root may be precisely located by the fixture, blade-to-blade dimensional variations result in uncertainty in the location of the blade tip relative to the fixture.

Accordingly, an arrangement for laser processing of a gas turbine blade is disclosed herein wherein the blade tip processing surface is secured in a predetermined and known position relative to a reference location such as the fixture frame. The blade is vertically supported from below on a movable and vertically adjustable base. Once the blade tip is in the predetermined and known position, laser processing may proceed without any custom programming of the laser or manipulator devices. Every like-design blade is secured with the same blade tip processing surface location, and blade-to-blade dimensional variations are accommodated as necessary by movement of the base, not by reprogramming of the laser or manipulator.

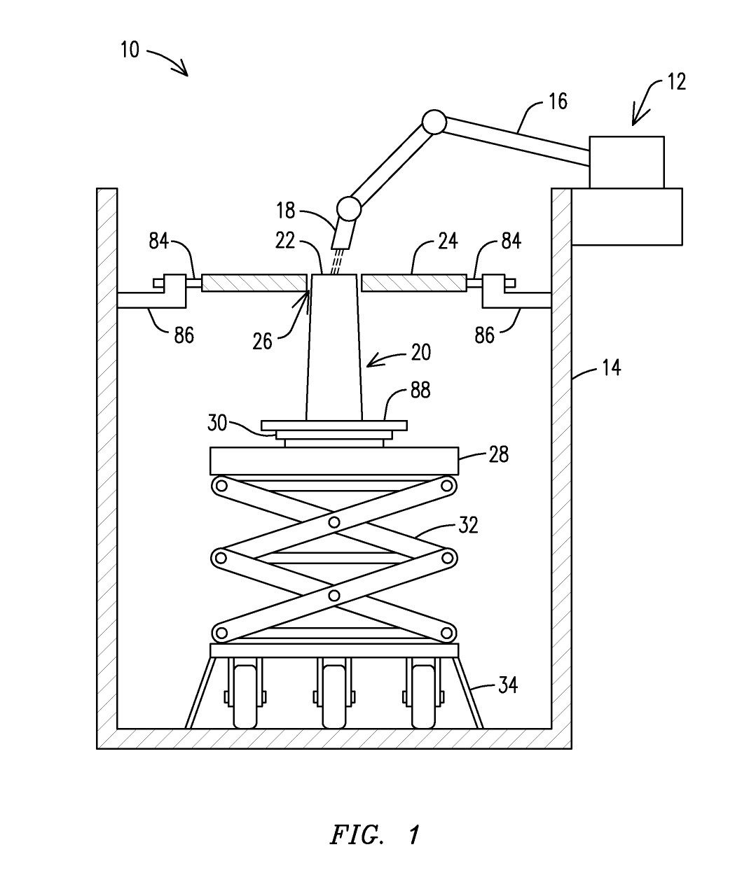

One embodiment of an arrangement 10 for laser processing of a gas turbine engine component is illustrated in FIG. 1. A laser material deposition device 12 is supported from or relative to a frame 14. Device 12 is schematically illustrated as including both a manipulator 16 and a laser 18, although one skilled in the art will appreciate that the positioning and energy production functions may be separately provided and controlled, and that such systems are well known in the art. The illustrated embodiment shows a gas turbine engine blade 20 undergoing a laser material deposition process to repair a tip 22 of the blade 20, although one skilled in the art will appreciate that other components subject to dimensional variations may be processed in other embodiments of the invention.

Arrangement 10 includes a plate 24 removeably supported by or from the frame 14 and defining an opening 26 for receiving the tip 22 of the blade 20. A positionable base 28 supports the blade 20 from proximate its root portion 30, as is normal in the art. However, the base 28 can be moved horizontally and/or allows free horizontal positioning of the base of the blade, and it can be extended vertically as required to locate the blade tip 22 at a predetermined position relative to the frame 14 (and therefore relative to the laser material deposition device 12) independent of dimensional deviations in the blade 20 that exist below the tip 22. As described above, service induced dimensional distortions typically occur along the airfoil portion 30 of a blade 20. The arrangement of FIG. 1 allows the blade tip 22 to be precisely located relative to the laser material deposition device 12, with service induced distortions being accommodated by vertical movement of the base 28 and otherwise by unconstrained lateral positioning of the balance of the blade body rather than by programming changes for the device 12. The base is illustrated as a scissors jack 32, such as a Lab Jack model Xtreme Z-12, mounted on a roller device 34.

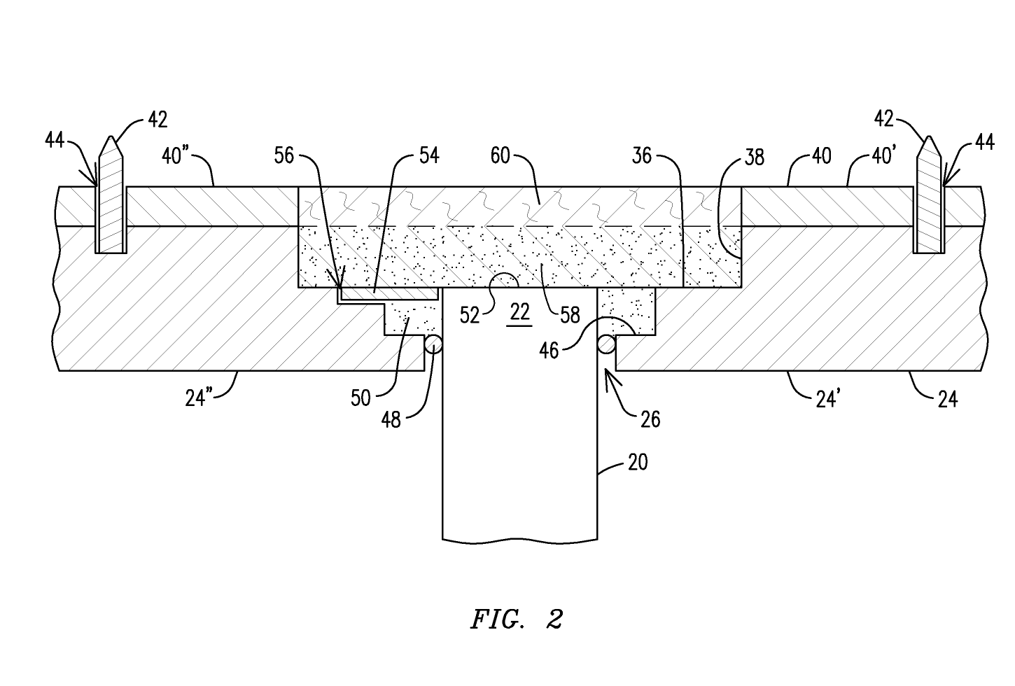

FIG. 2 provides a more detailed view of how the blade tip 22 may interface with the plate 24 in an embodiment of the invention. Because the material deposition process may produce some hang-over of newly deposited material which extends beyond the opening 26, it is helpful in some embodiments to form the plate 24 as a split plate having two or more portions 24′, 24″ that are separable about the opening 26 to facilitate the installation of the plate 24 into the arrangement 10 and the removal of the processed blade. The plate 24 includes an upwardly facing powder support surface 36 surrounding the opening 26, and a step 38 surrounding and extending upwardly from the powder support surface 36. A second plate 40, which may also be a split plate 40′, 40″, is optionally and removeably disposable on the step 38 of the first plate 24, and may be positioned by one or more pins 42 extending vertically from the plate 24 above the step 38 and through cooperating openings 44 formed in the second plate 40 when the second plate 40 is disposed on the first plate 24. A depression 46 may be formed into the first plate 24 between the opening 26 and the powder support surface 36. A seal 48 may be installed to fill any remaining gap between the plate 24 and the blade 20 to allow the depression 46 to be filled with powder, as will be described below. The seal 48 may be a welding blanket material, for example, fiberglass, vermiculite, or silica, such as silica string, or it may be a high temperature gasket material such as Resbond® (Cotromics), Mega Grey® (Versachem) or Ultra Copper (Permatex).

The embodiment of FIG. 2 may be utilized to deposit a new squealer tip onto blade 20 as follows. The blade tip 22 is prepared such as by grinding and cleaning as is known in the art. The blade 20 is then loaded onto the base 28 and supported at its root end 30 with the scissors jack 32 in a lowered position. The split plate pair 24′, 24″ is installed into the frame 14, and the scissors jack 32 is moved and expanded to position the tip 22 into the opening 26. Movement of the base 28 allows the top surface 52 of the tip 22 to be aligned with the powder support surface 36 in a processing plane or bed plane independent of dimension distortion that may exist below the tip 22.

After the seal 48 is installed, one or more run-on and/or run-off tabs 54 may be inserted into a tab pocket 56 formed into the powder support surface 36 adjacent the opening 26. Such tabs 54 are known to be used to avoid starting or stopping the laser material deposition process on the tip 22. Tabs 54 may typically be formed of the same superalloy material as the blade 20 or of graphite or zirconia.

For a material deposition process utilizing flux, as described in the aforementioned United States Patent Application Publication U.S. 2013/0136868 A1, a layer of flux powder 50 is deposited within the depression 46 to the height of the bed plane, even with the top surface 52 of the tip 22 and the powder support surface 36. The depth of the depression 46 is advantageously formed in accordance with a desired depth of this flux layer 50. A layer of superalloy powder 58 is then deposited over the blade tip top surface 52, the layer of flux 50 and the powder support surface 36 to a height of a powder plane determined by a height of the step 38. The second plate 40 is then assembled over the pins 42 onto the plate 24, and a layer of flux 60 is added to the height of a flux plane advantageously determined by a height of the second plate 40. The laser material deposition device 12 is then operated with its predetermined program to melt the alloy powder 58 to form a new squealer tip onto the blade 20.

One will appreciate that embodiments of the invention may be used without a separate flux powder, such as with a composite alloy/flux powder or with alloy powder alone. Such embodiments may preclude the necessity for the depression 46 and/or second plate 40.

The arrangement 10 may be used for more than one style of blade 20 by interchanging the first plate 24 with a second plate (not illustrated) defining an opening of a shape different than the shape of opening 26 of the first split plate 24.

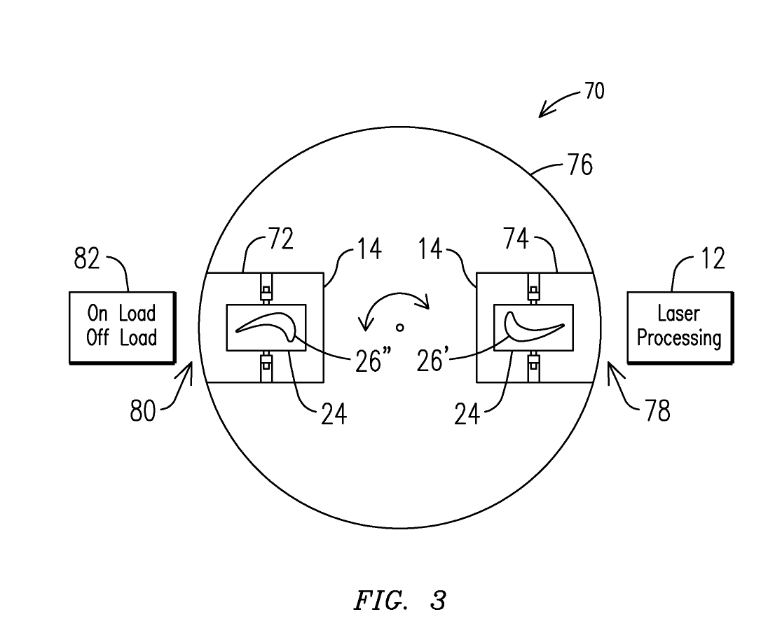

FIG. 3 illustrates a production operation 70 for laser processing of components wherein a plurality of fixtures 72, 74 is disposed on a positioner 76. The fixtures 72, 74 may be of the type illustrated in FIGS. 1 and 2, for example. The positioner 76 is illustrated as a turntable rotatable to interchange the locations of the fixtures 72, 74, although other types of positioners may be used, including linear, such that fixtures alternate between a central process location and loading/unloading locations that are disposed outside of the work cell. FIG. 3 illustrates fixture 74 at a processing position 78 proximate a laser material deposition device 12, and fixture 72 at a loading/unloading position 80 proximate material racks 82. Other embodiments may have more than two fixtures and more than two functional locations. This type of production operation 70 improves productivity because the operator can stay busy off-loading and on-loading components at the loading/unloading position 80 while the laser material deposition device 12 is operating autonomously at the processing position 78. It is desired that every component have its processing surface located precisely relative to the laser material deposition device 12 in spite of normal manufacturing tolerances in the fixtures 72, 74 and in the construction and operation of positioner 76. Accordingly, one or both of the fixtures 72, 74 may include a means for adjusting the location of the respective plate openings 26′, 26″ relative to the positioner 76 such that the processing surface of each respective component is consistently positioned relative to the laser material deposition device 12 when the respective fixture 72, 74 is moved to the processing position 78 by the positioner 76. The means for adjusting the location of the respective plate openings may be any type of adjustment mechanism disposed between the frame 14 and the plate 24. FIG. 1 illustrates one such mechanism as a set screw 84 operable by rotation to change a spacing between the plate 24 and a bracket 86 attached to the frame 14. Two sets of opposed set screws 84 may be used to effect adjustment in X and Y directions within a processing plane parallel to the top surface 52 of the blade tip 22. Other types of mechanisms may be used alone or in combination with such set screws to accomplish the adjustment, such as a slot/bolt arrangement (not shown) allowing the plate 24 to be moved along a linear or curvilinear slot path relative to the frame 14, and then to be affixed in a desired position by tightening the bolt.

While the arrangement 10 is particularly useful in eliminating the impact of dimensional distortions when performing a repair operation on the blade tip 22, other repair operations can nonetheless be performed on the blade 20 in conjunction with the tip repair. The inventors have recognized that certain types of repairs do not require the level of dimensional precision that is required for repairs such as a squealer tip replacement. For example, if a particular blade design has a propensity to develop cracks in a particular region of the blade platform 88, that region may be excavated and then refilled with material while the blade 20 is affixed in the arrangement 10. For that application, the service induced dimensional distortion of the blade 20 will result in a level of uncertainty as to the exact location of the platform 88, however, because of the size and mass of the platform 88, such uncertainty can be accommodated in the repair process without reprogramming of the laser material deposition device 12. Alternately, by preprocess machining removal of defective platform material relative to an existing post service orientation of the blade tip, the location for the platform repair operation can be precisely identified with a fixed tip location as described herein.

While various embodiments of the present invention have been shown and described herein, it will be obvious that such embodiments are provided by way of example only. Numerous variations, changes and substitutions may be made without departing from the invention herein. Accordingly, it is intended that the invention be limited only by the spirit and scope of the appended claims.

The invention claimed is:

1. An arrangement for laser processing of a gas turbine engine blade, the arrangement comprising:
a frame;
a first split plate removeably supported by the frame and defining an opening for receiving a tip of the blade when the plate is assembled on the frame, the first split plate comprising a powder support surface surrounding the opening; and
a positionable base for supporting the blade such that a top surface of the tip aligns with the powder support surface in a processing plane when the blade is supported on the base;
wherein the first split plate opening is effective to locate the blade tip at a predetermined position relative to the frame for a laser material deposition process independent of dimensional deviations in the blade below the tip.

2. The arrangement of claim 1, wherein the first split plate further comprises a step surrounding and extending upwardly from the powder support surface, a height of the step corresponding to a predetermined desired depth of alloy powder to be disposed on the powder support surface for the laser material deposition process.

3. The arrangement of claim 2, further comprising a second split plate removeably disposable on the step of the first split plate, a height of the second split plate corresponding to a predetermined desired depth of flux powder to be disposed on the alloy powder for the laser material deposition process.

4. The arrangement of claim 3, further comprising a pin extending vertically above the step from the first split plate and a cooperating opening formed in the second split plate for receiving the pin when the second split plate is disposed on the step of the first split plate.

5. The arrangement of claim 1, further comprising a depression formed into the first split plate between the opening and the powder support surface, a bottom surface of the depression defining a bed plane.

6. The arrangement of claim 1, wherein the height adjustable base comprises a scissors jack.

7. The arrangement of claim 1, further comprising:
a tab pocket formed into the powder support surface adjacent the opening; and
a tab disposed in the tab pocket for run-on or run-off of the laser material deposition process.

8. The arrangement of claim 1, further comprising a moveable positioner supporting the frame, wherein the arrangement comprises one of multiple arrangements for laser processing of gas turbine engine blades disposed on the positioner, the positioner operable to position any selected one of the multiple arrangements relative to laser material deposition equipment.

9. The arrangement of claim 1, further comprising a position adjustment mechanism between the frame and the first split plate for adjusting a position of the opening relative to the frame within the processing plane.

10. The arrangement of claim 1, further comprising a seal disposable within the opening between the first split plate and the blade tip during the material deposition process.

11. The arrangement of claim 10, wherein the seal comprises a silica string.

12. The arrangement of claim 1, further comprising a second split plate defining an opening of a different shape than the opening of the first split plate, the second split plate interchangeable with the first split plate in the arrangement for receiving a tip of a blade of a different design.

13. An arrangement for processing of a gas turbine engine component, the arrangement comprising:
a fixture comprising a plate defining an opening; and
a base connectable to the component at a support location, the base moveable relative to the plate to position a processing surface of the component at a predetermined processing location relative to the opening regardless of dimensional deviations in the component between the support location and the processing surface.

14. The arrangement of claim 13, wherein plate comprises two portions separable from each other at the opening to facilitate removal of the component from the opening following a laser material deposition process.

15. The arrangement of claim 13, wherein the plate comprises a step defining limits of a powder support surface surrounding the opening, a height of the step corresponding to a desired depth of a first powder to be disposed on the processing surface.

16. The arrangement of claim 15, further comprising a second plate removeably disposable on a top surface of the step, a height of the second plate corresponding to a desired depth of a second powder to be disposed over the first powder.

17. The arrangement of claim 13, wherein the component comprises a gas turbine engine blade, the base comprises a scissors jack positionable under a root of the blade, and the processing surface comprises a surface of a tip of the blade.

18. The arrangement of claim 13, where the fixture further comprises:
a frame; and
an adjustable connection between the plate and the frame, the adjustable connection effective to position the opening relative to the frame at a desired location.

19. An arrangement for laser processing of a component, the arrangement comprising:
a moveable positioner;
a plurality of fixtures disposed on the positioner, the positioner operable to position any selected one of the fixtures at a processing position proximate a laser material deposition device; and
each fixture comprising an opening adapted to receive and to position a processing surface of a respective component mounted in the fixture at a predetermined processing location relative to the positioner regardless of dimensional deviations in the component remote from the processing surface.

20. The arrangement of claim 19, further comprising a means for adjusting a location of each respective opening relative to the positioner such that the processing surface of each respective component is consistently positioned relative to the laser material deposition device when each respective fixture is moved to the processing position by the moveable positioner.
